(19) United States
(12) Patent Application Publication
(10) Pub. No.: US 2014/0144546 A1
(43) Pub. Date: May 29, 2014

(54) GAS BARRIER, AND FILLING ELEMENT HAVING AT LEAST ONE GAS BARRIER

(71) Applicant: Hans-Martin Schwarz, Niederzissen (DE)

(72) Inventor: Hans-Martin Schwarz, Niederzissen (DE)

(21) Appl. No.: 14/130,575

(22) PCT Filed: Jun. 2, 2012
(86) PCT No.: PCT/EP2012/002400

§ 371 Date: Jan. 2, 2014

(30) Foreign Application Priority Data
Jul. 1, 2011 (DE) 10 2011 107 858.8

(51) Int. Cl. B67D 7/54

(52) U.S. Cl. CPC B67D 7/54
USPC 141/51

(57) ABSTRACT

A gas barrier arranged in a flow path of a liquid filling material with which containers are to be filled has a lattice-like honeycomb structure having a multiplicity of hexagonal channels. The channels are open on a gas-barrier top-side and a gas-barrier underside and separated from one another by ribs.

### RELATED APPLICATION

This application is the national stage entry under 35 USC 371 of PCT/EP2012/002400, filed on Jun. 6, 2012 which, under 35 USC 119, claims the benefit of the priority date of German application DE 10 2011 107 858.8, filed on Jul. 1, 2011, the contents of which are herein incorporated by reference.

### FIELD OF INVENTION

The invention relates to filling of containers, and in particular, to a gas barrier for use in a filling element.

### BACKGROUND

The use of gas barriers in filling elements for the filling of bottles or similar containers is known, for example in the case of the open jet filling of containers, in order to prevent unwanted dripping of filling material from the filling element after the filling element's liquid valve has closed, or for example in the case of filling elements for the pressure-filling of containers with return gas tubes that control the fill level, in order to prevent air bubbles and/or gas bubbles from rising out of the head space of the filled container into the liquid channel configured in the filling element.

Gas barriers usually comprise a strainer-like structure having a multiplicity of openings or channels separated by wall sections or ribs and whose cross-section or internal dimension and axial length are selected so as to guarantee an uninterrupted flow of filling material through the channels and to use the surface tension of the filling material to hold it back in the gas barrier, thereby preventing filling material from continuing to run or drip after closing the liquid valve of the filling element that has the gas barrier.

In some known gas barriers, the strainer-like structure is formed by a multiplicity of circular openings or channels, with such gas barriers comprising, for example, a large number of thin and thin-walled tubelets interconnected, by a suitable technique such as brazing or welding, to form the strainer-like structure of the gas barrier. Workers in the art assume here that the surface tension of the filling material, which creates the sealing and/or gas-barrier effect, is more effective as the cross-section area of each channel becomes more circular. The conventional wisdom in the art therefore has been to avoid sharp edges or angles on the inside face of the channels.

However, because circles do not pack together efficiently, the use of channels with a circular cross-section, in particular also the use of tubelets forming these channels, results in undesired corners, or gussets, between adjacent channels or tubelets. These corners or gussets are are blind or dead spaces through which the filling material does not flow or whose internal dimensions are so much reduced there is a danger of blockage and possibly even of bacterial contamination.

Gas barriers are also known, from DE 10 2004 013 211 A1, AT 294 609, and U.S. Pat. No. 2,558,238, that each consist of an outer annular body or ring-shaped section and of ribs protruding into the annular space and/or of wall elements arranged in the annular space forming a simple or multiple or star-like structure within the annular space.

Also known, for example from DE 41 40 524 A1, are gas barriers made from a thin-walled material in which are configured a multiplicity of openings whose cross-section or internal dimension is roughly equal to their axial length

### SUMMARY

The object of the invention is to provide a gas barrier whose strainer-like structure exhibits an improved passage characteristic combined with an optimal gas-blocking function while avoiding blind or dead spaces, in particular also while avoiding dead spaces that create the risk of bacterial contamination.

For the purpose of the invention, the term “passage characteristic” means the ratio of the total cross-sectional area of the channels through which the filling material can flow to the closed total cross-sectional area of the gas barrier, the closed total cross-sectional area being essentially determined by the wall sections or ribs between the channels and by the outer annular body or ring-shaped section enclosing a honeycomb structure.

“Containers,” for the purpose of the invention, include bottles, cans, and soft packaging, for example pouches produced from card and/or plastic film and/or metal foil.

The term “open jet filling” in the sense of the invention refers to a method in which the liquid filling material flows to the container to be filled in an open filling jet, with the container not lying with its container mouth or container opening directly against the filling element but being spaced apart from the filling element or from the latter's filling material outlet.

For the purpose of the invention the expressions “essentially”, “in essence,” or “around” mean variations from the respective exact value by +/−10%, preferably by +/−5% and/or variations in the form of changes insignificant for the function.

“Honeycomb-like”, for the purpose of the invention means a hexagonal configuration, including a configuration corresponding to an equilateral hexagon.

Because of the honeycomb-like or hexagon-like configuration of the openings or channels over their entire length, or at least over by far the greatest part of their length, it is possible to optimally use the respectively available total cross-section of the gas barrier for these channels by avoiding blind or dead spaces and yet to keep their internal dimensions so small that the gas-barrier effect is achieved even when taking the surface tension of the filling material into account.

It has been shown, for example in the case of a filling material in the form of a still water, that the passage characteristic of the gas barrier compared with that of a conventional gas barrier of the same size can be significantly improved with the inventive configuration to the extent that the time needed to fill a container is reduced by up to 20%.

The inventive configuration of the gas barrier, especially when the latter is provided in the region of the filling material outlet or filling material delivery of the filling element, achieves a very homogeneous and linear jet formation in such a way that no or essentially no air bubbles or gas bubbles are generated when the filling material jet is immersed into the filling material level rising in the container. The dispensing rate of the filling valve measured in liters per second can be significantly increased by this very beneficial jet formation without there being any unwanted foaming of the filling material. The output of the filling machine, measured in containers per hour, can also be increased because the particular filling process can be continued at a very high dispensing or filling rate of the filling valves far into a tapering region of the container, as a result of which the slow filling phase of a filling process that usually follows the end of a fast filling phase can be initiated later than was previously possible, thereby enabling the time needed to fill a container to be significantly reduced.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

### BRIEF DESCRIPTION OF THE DRAWINGS

The invention is explained in detail below through the use of an embodiment example with reference to the figures. In the figures:

FIG. 1 shows a very schematic representation and side view of a filling element for the open jet filling of containers in the form of bottles;

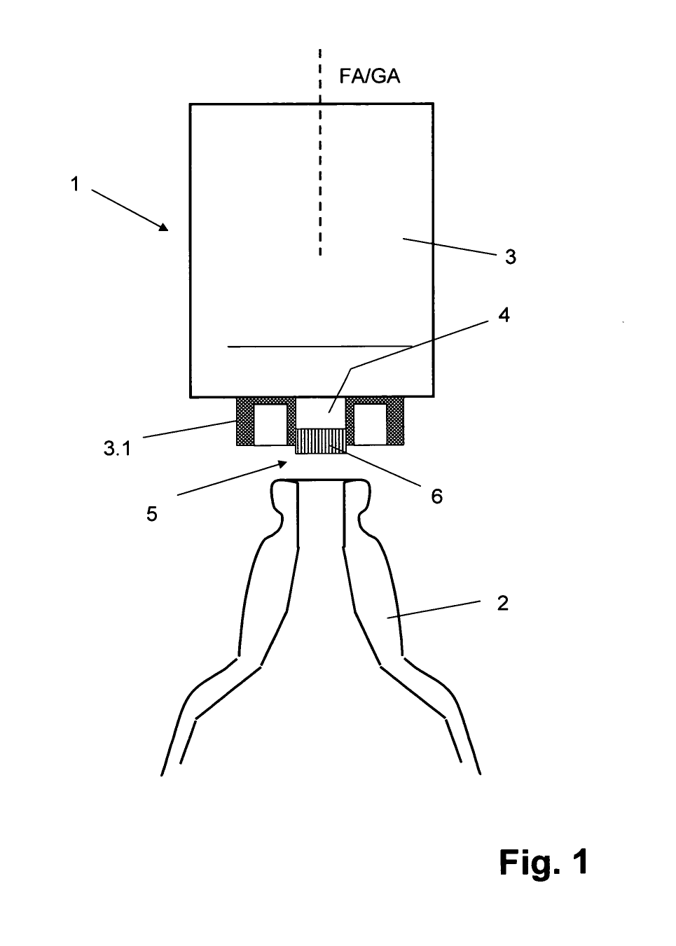

FIG. 2 shows a perspective single representation of a gas barrier of the filling element of FIG. 1;

FIGS. 3 and 4 show the gas barrier of FIG. 2 in plan view and in section on line A-A of FIG. 3;

FIG. 5 shows an enlarged partial representation of FIG. 3 according to detail V;

FIG. 6 shows an enlarged partial representation of the section of FIG. 4 according to detail X.

### DETAILED DESCRIPTION

In the figures, 1 is a filling element of a filling system, for example of a rotary-type filling machine for the open jet filling of containers in the form of bottles 2 with a liquid filling material. Filling element 1, which is, for example, provided with a multiplicity of uniform filling elements 1 on the periphery of a rotor (not shown) that can be driven to rotate about a vertical machine axis, comprises, among other things, a liquid channel 4 configured in a filling element housing 3 and which forms a filling material delivery 5 on the underside of filling element 1 and in which a liquid valve (not shown) for the controlled delivery of the filling material into respective bottle 2 is provided inside filling element housing 3.

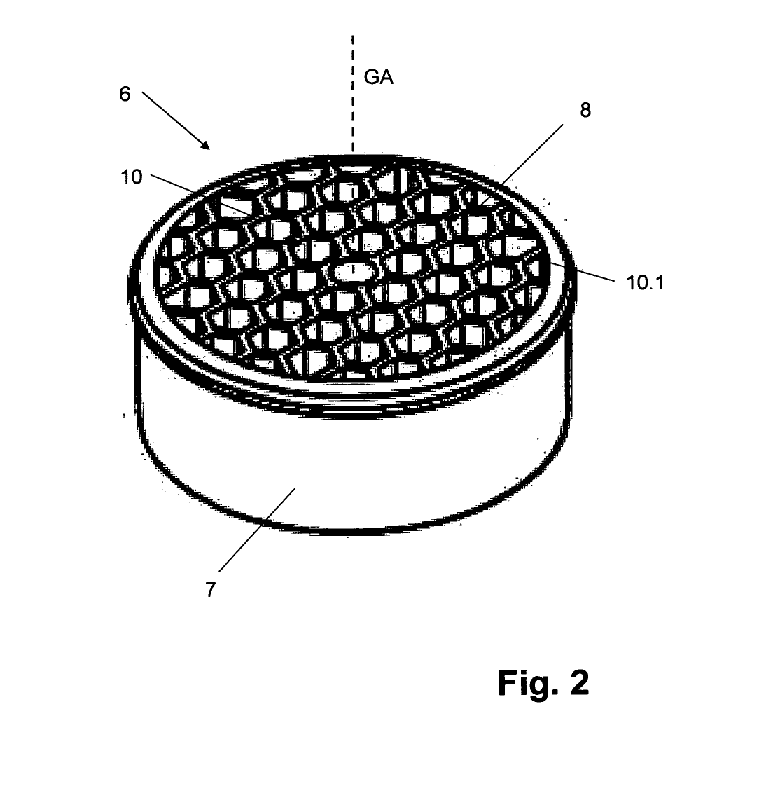

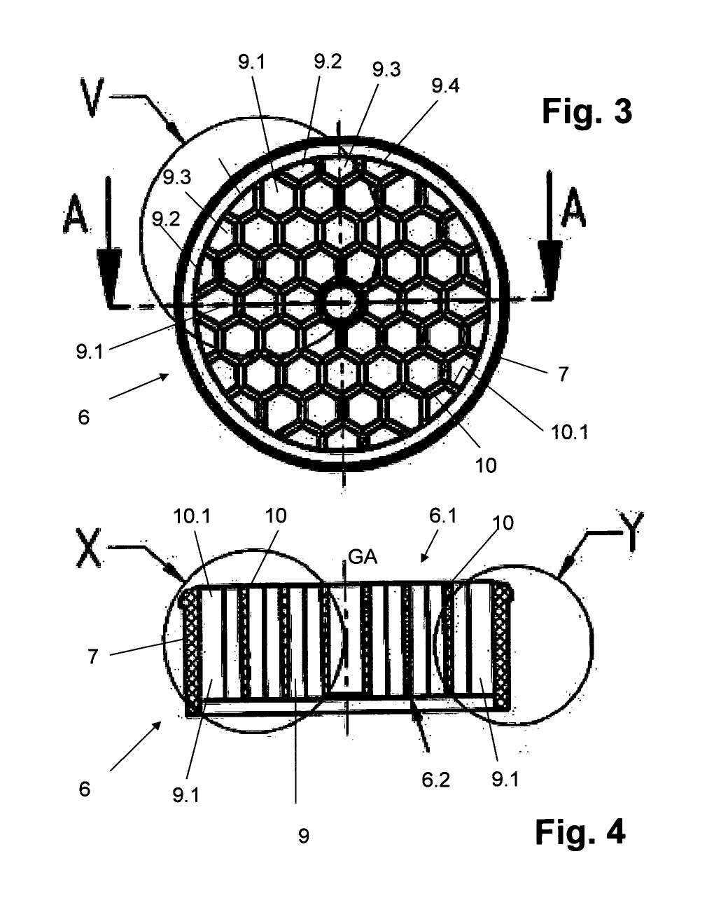

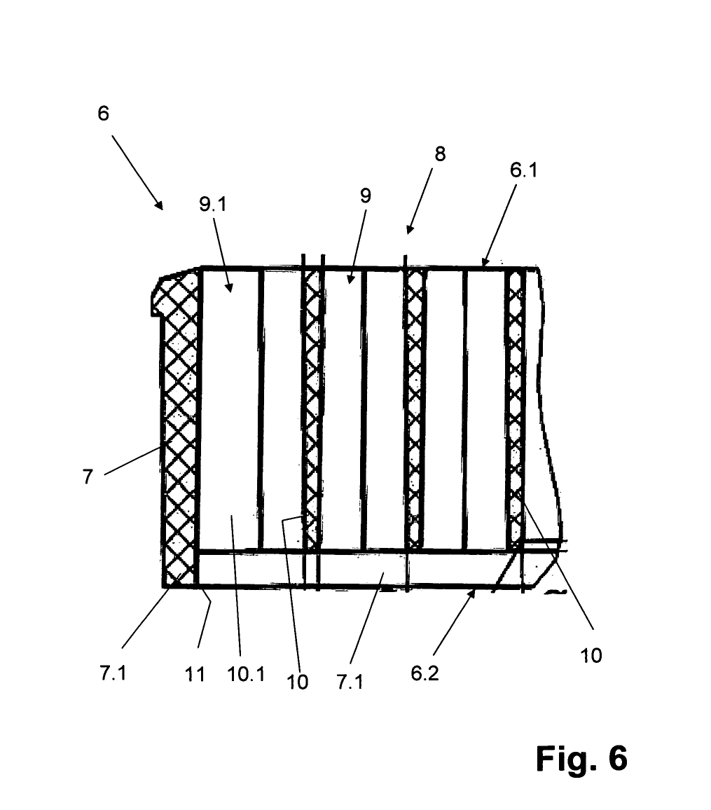

A gas barrier 6, which in the depicted embodiment forms the filling material delivery 5 and which exhibits the special configuration depicted in FIGS. 2-6, is disposed in liquid channel 4. Gas barrier 6, which in the depicted embodiment is mounted so that, when seen in the direction of the vertical filling element axis FA, it projects by part of its length beyond the underside of filling element housing 3 or of housing section 3.1, which exhibits filling material delivery 5, is manufactured in the depicted embodiment as a circular, one-piece molding from a product-neutral material, for example plastic and/or a corrosion-resistant metal material, which is advantageous but not mandatory.

Specifically, gas barrier 6 comprises an annular body or annular section 7 that forms a continuous peripheral wall and whose interior space is occupied by a honeycomb-like structure 8 that is formed by a multiplicity of openings or channels 9 and 9.1-9.4 whose axes run parallel to one another. In detail, the honeycomb-like structure 8 is executed so that for a constant or essentially constant wall thickness of section 7, only channels 9.1-9.4, which are provided immediately at the inner face of ring-shaped section 7, and which are outwardly bounded by this ring-shaped section relative to axis GA, form modified honeycombs, i.e. are modified channels, whereas all other channels 9 exhibit the cross-section of an unmodified honeycomb, i.e. the cross-section of an equilateral hexagon.

The internal dimension or inner cross-section and length of channels 9 and 9.1-9.4 is selected such that honeycomb-like structure 8 acts as a gas barrier, i.e. following the respective closing of the liquid valve of the filling element, and in particular taking account of the surface tension of the liquid filling material, the latter is held back in gas barrier 6 and in that part of liquid channel 4 which exhibits gas barrier 6 and which follows the continuous filling material in the direction of flow, whereby an unwanted dripping of the filling material after the closing of the liquid valve is prevented.

Channels 9, which are separated by a multiplicity of ribs 10, each possess a honeycomb-like or hexagonal cross-section, i.e. a cross-section corresponding to an equilateral hexagon, and are configured with their axes parallel to one another and parallel to the axis of ring-shaped section 7 or to gas barrier axis GA, albeit with the exception of modified channels 9.1-9.4 immediately adjacent to ring-shaped section 7 and separated from one another by ribs 10.1. These modified channels possess a cross-section that differs from the honeycomb form in the way described in greater detail below.

In the depicted embodiment the cross-section or internal dimension of channel 9 is selected so that two cross-section sides lying opposite one another and running parallel to one another each exhibit a distance on the order of 1.9 millimeters-2.35 millimeters, preferably a distance of around 2 millimeters. The axial length of channels 9, and hence also the dimension exhibited by honeycomb-like structure 8 in the direction of axis GA, ranges from around 7.6 millimeters to 8.4 millimeters, and is preferably around 8 millimeters, in the depicted embodiment. The length-to-internal-dimension aspect ratio of channels 9 ranges between three and five millimeters in the depicted embodiment.

The wall thickness of ribs 10 and 10.1 is less than 0.7 millimeters, for example equal to or less than 0.5 millimeters. In the depicted embodiment the wall thickness of ribs 10 and 10.1 ranges between 0.4 millimeters and 0.6 millimeters. Ribs 10 and 10.1 are preferably configured so that their wall thickness decreases as one approaches the gas-barrier underside 6.2, for example in such a way that the wall thickness of ribs 10 and 10.1 on the gas-barrier underside 6.2 is only 70% to 90% of the wall thickness on the gas-barrier top side 6.1 and thereby the internal dimension or cross-section of channels 9 also increases accordingly from the gas-barrier top side 6.1 to the gas-barrier underside 6.2, and in such a way for example that the cross-section on gas-barrier underside 6.2 is greater than that on gas-barrier top side 6.1 by 2% to 4%, for example by around 3%. Ribs 10 and 10.1 on gas-barrier underside 6.2 are also rounded.

In the depicted embodiment, gas barrier 6 possesses an outside diameter ranging between 21.5 millimeters and 24.5 millimeters, and preferably has an outside diameter of around 23 millimeters. Also in the depicted embodiment, gas barrier 6 has an inside diameter of around 20 mm-22 mm, preferably has an inside diameter of around 21 millimeters.

Gas barrier 6 is moreover formed so that while the top side of honeycomb-like structure 8 on gas-barrier top side 6.1 lies level with the top side of ring-shaped section 7, the latter projects on gas-barrier underside 6.2 beyond the underside of honeycomb-like structure 8 with a projection of between around 0.95 millimeters and 1.05 millimeters, and preferably with a projection of around 1 millimeter.

One essential feature of gas barrier 6 is moreover that outer annular section 7 on gas-barrier underside 6.2 is provided on its margin, which at that point lies on the inside, with a sharp edge, i.e. with sharp edge 11. This sharp edge 11 is formed by the lower ring-shaped end face of section 7 blending directly, i.e. without any rounding, at edge 11 into the inner face of projection 7.1 cylindrically enclosing axis GA. In conjunction with projection 7.1 and the rounding of ribs 10 and 10.1, sharp edge 11 ensures that the individual jets flowing through from channels 9 and 9.1-9.4 on gas-barrier underside 6.2 form an overall even jet of filling material and that, to this end, the individual jets of channels 9.1-9.4 in particular also detach well from the inner face of ring-shaped section 7 and integrate into the overall jet of filling material without splashing.

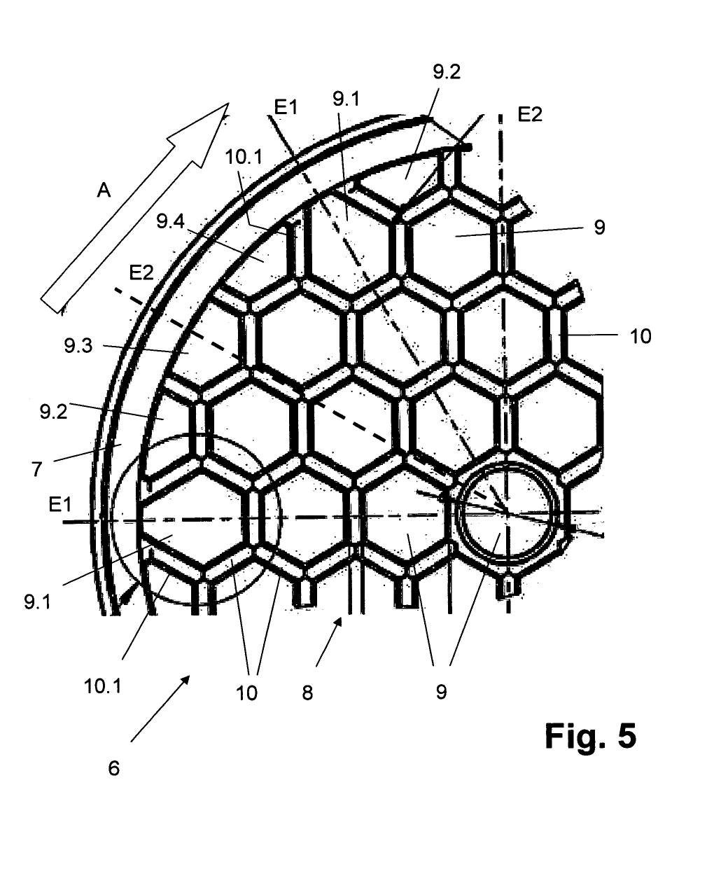

The outer modified channels are indicated in FIG. 5 by 9.1-9.4 and lie adjacent to one another in ascending order of reference number following a peripheral direction of gas barrier 6 as assumed by arrow A. Channels 9.1-9.4 do not, however, for example, necessarily form uniform groups of channels to the extent that each channel group of four modified channels 9.1-9 is followed in the assumed peripheral direction A by a further channel group also comprising four modified channels 9.1-9.4. Each channel group extends over a certain angular range about gas barrier axis GA, with the size of the angular range being determined by the number of groups of channels. With six groups of channels, for example, the angular range is 60°. Regarding the configuration of their channels and their sequential order in assumed peripheral direction A, the groups of modified channels 9.1-9.4 are preferably identical because the manufacturing costs can be reduced by this approach.

In FIG. 5, references E1 each designate two planes that, enclosing gas barrier axis GA, extend radially to that axis and are offset relative to one another at an angle of 60° about gas barrier axis GA. Again in FIG. 5, references E2 each designate two planes that, enclosing gas barrier axis GA, also extend radially to that axis and are offset at an angle of 60° relative to one another about gas barrier axis GA and additionally by an angle of 30° relative to planes E1.

As FIG. 5 shows, the honeycomb-like structure is in detail executed so that each plane E1 intersects, at right angles, ribs 10 that separate channels 9 and 9.1, and so that channels 9 and 9.1 are disposed along plane E1 with their axes also in that plane. Planes E2 each extend along ribs 10 that are radially oriented to gas barrier axis GA, and extend in such a way that, along each plane E2, ribs 10 alternate with channels 9 and 9.3, which are disposed with their axes in plane E2.

On planes E1, outer channels 9.1 are executed such that the two ribs 10.1, which blend into ring-shaped section 7, diverge starting from the inner face of section 7, with these ribs in the depicted embodiment being longer than the other ribs 10 enclosing respective channel 9.1. The distance exhibited by ribs 10.1 from one another on ring-shaped section 7 is also less than one side length of the hexagonal cross-section of unmodified channel 9 or the length of ribs 10. In the region of planes E2, ribs 10.1 of channels 9.3, which blend into ring-shaped section 7, are executed such that these ribs run parallel to one another and parallel to respective plane E2.

As is also shown in FIG. 5, there are disposed, between outer modified channels 9.1 and 9.3 associated in planes E1 and E2, three further modified channels 9.2, 9.3, 9.4 and 9.4, 9.1 and 9.2 respectively.

The invention has been described hereinbefore by reference to one embodiment. It goes without saying that numerous variations as well as modifications are possible without departing from the inventive concept underlying the invention. Common to all embodiments is that the passages of the respective gas barrier are formed by channels of a honeycomb structure such that, given a cross-section and/or aspect ratio of the channels that is optimally selected for the function of the gas barrier, the greatest possible total cross-section in conjunction with a very homogeneous and laminar configuration of the jet of filling material is achieved by making optimal use of the available total cross-section and of the avoidance of dead spaces.

It has been assumed above that gas barrier 6 is provided directly at filling material delivery 5, i.e. that it actually forms the filling material delivery. The inventive gas barrier can of course also be deployed to identical advantage in other regions of the respective filling element or of the liquid channel which is there located.

In a further embodiment of the present invention at least parts of the surfaces and edges of ribs 10, 10.1 be machined. To this end, the surfaces or edges of ribs 10, 10.1 are to be machined by blasting (for example by blasting with glass beads or sand), by embossing, or bending, etc. such that the filling material adheres to the machined surfaces or edges to a greater degree, thereby making the gas barrier less sensitive to undesirable influences such as for example vibrations or centrifugal forces.

In other embodiments, the lower edges of ribs 10,10.1 are machined with a wave-like profile, thus significantly increasing the lengths of the lower edges of ribs 10, 10.1, which in turn leads to an improved usability of a gas barrier machined in this way. In an optional feature of the machining process, at least parts of the surfaces and/or at least parts of the edges of ribs 10, 10.1 are provided with indentations, thereby improving the usability of the gas barrier.

In a further embodiment of the present invention, the previously described special features of the surfaces and/or edges of ribs 10, 10.1 are manufactured not by machining but during the initial production of the actual gas barrier, i.e. for example during injection molding, that is to say by primary forming. According to the invention all surface features such as, for example, indentations and/or wavy lines, can be formed by primary forming or by machining.

### LIST OF REFERENCE CHARACTERS

1 Filling element
2 Bottle
3 Filling element housing
3.1 Housing section
4 Liquid channel
5 Filling material delivery
6 Gas barrier
6.1 Gas-barrier top side
6.2 Gas-barrier underside
7 Ring-shaped section
7.1 Projection
8 Honeycomb structure
9 Channel
9.1-9.4 Modified channel
10, 10.1 Rib
11 Edge
FA Filling element axis
GA Axis of the circular gas barrier 6
E1,E2 Plane

1-19. (canceled)

20. An apparatus comprising a gas barrier arranged in a flow path of a liquid filling material with which containers are to be filled, wherein said gas barrier defines a gas-barrier axis, wherein said gas barrier comprises a lattice-like honeycomb structure having a multiplicity of channels that have a hexagonal cross section, wherein said channels are open on a gas-barrier top-side and a gas-barrier underside, and wherein said channels are separated from one another by ribs.

21. The apparatus of claim 20, wherein said channels have an equilateral hexagonal cross-section.

22. The apparatus of claim 20, wherein said gas barrier is formed from a single piece of material, said material being selected from the group consisting of plastic and metal.

23. The apparatus of claim 20, wherein said channels each define an axis that is parallel to said gas-barrier axis.

24. The apparatus of claim 20, wherein said gas barrier comprises a ring-shaped section that forms a peripheral surface of said gas barrier, wherein said ring-shaped section encloses said honeycomb structure.

25. The apparatus of claim 24, further comprising modified channels provided along an inside of said ring-shaped section, wherein said modified channels form groups of channels, wherein, in each of said groups, a plurality of modified channels adjoin one another in an assumed peripheral direction each of which extends over an angular range of 60° about said gas barrier axis, and wherein said groups of channels are configured identically in regard to form and sequential order of said modified channels.

26. The apparatus of claim 25, wherein each group of channels comprises a modified channel having a cross-section delimited by an inner face of said ring-shaped section and by five ribs, and at least one further channel having a cross-section delimited by said inner face and by three ribs.

27. The apparatus of claim 25, wherein said modified channels have a first total surface measure, wherein said hexagonal channels have a second total surface measure, and wherein a ratio of said first total surface measure and said second total surface measure is less than one.

28. The apparatus of claim 20, wherein one of said multiplicity of channels is coaxial with said gas barrier axis.

29. The apparatus of claim 20, wherein said channels have an internal dimension of between 1.9 mm and 2.5 mm.

30. The apparatus of claim 20, wherein, on said gas-barrier underside, said ribs are rounded

31. The apparatus of claim 20, further comprising a projection extending beyond said gas-barrier underside.

32. The apparatus of 31, wherein said projection extends a distance between 0.95 mm and 1.05 mm.

33. The apparatus of claim 20, wherein said channels have internal dimensions that increase with distance from said gas-barrier top-side.

34. The apparatus of claim 33, wherein each of said channels have an internal dimension at said underside that is between 2% and 4% greater than said internal dimension at said gas-barrier top-side.

35. The apparatus of claim 20, wherein each of said channels has an axial length and an internal dimension, and wherein said axial length is greater than said internal dimension.

36. The apparatus of claim 20, wherein each of said channels has an axial length and an internal dimension, and wherein said axial length is between three and five times said internal dimension.

37. The apparatus of claim 20, wherein said ribs have a wall thickness that is less than 0.7 mm.

38. The apparatus of claim 20, wherein parts of said ribs comprise indentations.

39. The apparatus of claim 20, further comprising a filling element configured for open jet filling of containers with said liquid filling material, and wherein said gas barrier is disposed in a flow path defined by said filling element for said liquid filling material.

40. The apparatus of claim 39, wherein said filling element comprises a filling material outlet and said gas barrier is disposed at said outlet.
